(19) United States
(12) Patent Application Publication
(10) Pub. No.: US 2008/0008592 A1
(43) Pub. Date: Jan. 10, 2008

(54) METHOD AND APPARATUS FOR CONTROLLING TONAL NOISE FROM SUBSONIC AXIAL FANS

(75) Inventors: Anthony Gerard, Sherbrooke (CA); Alain Berry, Sherbrooke (CA); Patrice Masson, Sherbrooke (CA); Yves Gervais, Poitiers (FR)

Correspondence Address: OSLER, HOSKIN & HARCOURT, LLP (U. DE SHERBROOKE), 1000 DE LA GAUCHETIERE STREET WEST, SUITE 2100, MONTREAL, QC, H3B-4W5, CA

(73) Assignees: SOCIETE DE COMMERCIALISATION DES PRODUITS DE LA RECHERCHE APPLIQUEE - SOCPRA-SC, Sherbrooke (CA); CENTRE NATIONALE DE LA RECHERCHE SCIENTIFIQUE, Paris Cedex 9 (FR); UNIVERSITE DE POITIERS, Poitiers Cedex (FR)

(21) Appl. No.: 11/769,125

(22) Filed: Jun. 27, 2007

Related U.S. Application Data
(60) Provisional application No. 60/805,944, filed on Jun. 27, 2006.

(51) Int. Cl. B64C 27/46

(52) U.S. Cl. 416/203; 415/119

(57) ABSTRACT

A method and apparatus for reducing a selected tonal noise generated by an axial flow fan operating in a non-uniform flow by locating at least one obstruction in the non-uniform flow such that the at least one obstruction generates a noise that is out of phase with the selected tonal noise. The noise generated by the at least one obstruction interferes with the selected tonal noise, thus reducing the selected tonal noise. It is also contemplated to use additional obstructions to reduce other tonal noises generated by the axial flow fan.

### CROSS-REFERENCE

The present application claims priority to U.S. Provisional Patent Application No. 60/805,944 filed on Jun. 27, 2006, the entirety of which is incorporated herein by reference.

### FIELD OF THE INVENTION

The present invention relates to a method and apparatus for controlling tonal noise from subsonic axial fans.

### BACKGROUND OF THE INVENTION

Tonal noise mainly originates from flow irregularity (non-uniform flow) that causes circumferentially varying blade forces and gives rise to a considerably large radiated dipolar sound (tonal noise) at the blade passage frequency (BPF) and its harmonics. Although some axial fans operate in an environment where the flow is uniform, as schematically illustrated in FIG. 2A, in many instances, axial fans operate in a non-uniform flow, as schematically illustrated in FIG. 2B: this is the case, for example, of engine cooling fans that operate behind a radiator/condenser system or in the wake of inlet guide vanes.

Techniques to control fan noise can be classified into two main families: active control or passive control. Passive methods are principally based on the geometrical characteristics of the propeller and its environment to reduce the noise generation mechanisms (reduce fluctuating forces or minimize their acoustic effects). Passive techniques can be considered as preventive techniques. However, it is not always possible to apply such modifications, especially in case of confined environments, such as automotive engine cooling fans. In such cases, active techniques have been proposed. Active techniques are effective at low frequencies, where passive techniques (such as using absorbing materials) are inefficient. Active techniques use the destructive interference between two waves to attenuate the noise. This is done by a secondary noise generated by a secondary source (loudspeaker for example) that interferes with the fan's primary noise. Active techniques can be considered as corrective techniques.

A number of solutions for controlling tonal noise in axial fans have been proposed. U.S. Pat. No. 6,375,416 presents a technique and an apparatus based on sinusoidal circumferential variation of the tip clearance to create a unsteady pressure field opposite in phase with respect to the primary unsteady pressure field, thus reducing tonal noise. The proposed technique is based on sinusoidal variations of the inner surface of the shroud. U.S. Pat. No. 5,692,702 describes a method as well as a system to control tonal noise generated by a ducted-rotor. The method relies on the introduction of upstream or downstream flow distortions to create an anti-sound opposite in phase with respect to the primary tonal noise. An acoustic signal from one or more microphone arrays provides information to adjust each circumferential modal component of the flow. Two methods for producing the distortions are proposed. The devices are mounted in a circumferential array on the duct wall and consist of either 1) nozzles actively exhausting or ingesting controlled amount of air or 2) rods with actively controlled protrusion into the flow. However, for the subject matter described in this patent, every modal components must be adjusted.

FIG. 1A schematically illustrates an adaptation of another prior art solution. A number of cylindrical rods 2A were mounted on a rotatable ring 4. Turning the ring 4 allowed for adjusting the phase of the control mode so that a reduction at the BPF was achieved when the two modes were out of phase. However, the wakes generated by the rods 2 are salient, leading to a high harmonic content rate of the unsteady lift. Thus, the high harmonic content rate can lead to amplification of higher acoustic tones when attempting to control tonal noise at the BPF.

Therefore, there is a need for a passive method and apparatus for controlling a tonal noise which does not significantly amplify higher acoustic tones. There is also a need for a passive method and apparatus for controlling a tonal noise which can be used in a confined environment.

### SUMMARY OF THE INVENTION

One aspect of the present invention provides a passive method and apparatus for controlling a tonal noise which does not significantly amplify higher acoustic tones.

In another aspect, the present invention provides a passive method and apparatus for controlling a tonal noise which can be used in a confined environment.

A further aspect of the invention provides the use of one or more obstructions in a non-uniform flow to destructively interfere with a tonal noise generated by the blades of the rotor of an axial fan, and to provide a method for locating the one or more obstructions.

In another aspect, the invention provides a method for reducing tonal noise generated by an axial flow fan comprising: providing an axial flow fan having a rotor rotatable about an axis, the rotor having a number of blades; rotating the rotor in a non-uniform flow causing the number of blades to generate a first tonal noise at a blade passage frequency of the rotor and other tonal noises at harmonics of the blade passage frequency, the harmonics being integer multiples of the blade passage frequency; selecting a tonal noise to be reduced; locating at least one obstruction at an initial position being at a first distance radially away from the axis and at a second distance axially away from the rotor; moving the at least one obstruction around the axis at a first intermediate position where the selected tonal noise is reduced; modifying the second distance to locate the at least one obstruction at a second intermediate position where the selected tonal noise is further reduced; and repeating the steps of moving the at least one obstruction and modifying the second distance until a desired level of reduction of the selected tonal noise is obtained such that the at least one obstruction is located at a final position. The at least one obstruction is shaped such that an interaction of the at least one obstruction with the rotor has a low harmonic content rate at the final position.

In an additional aspect, the first distance is less than a span length of one of the number of blades.

In a further aspect, the method further comprises modifying the first distance.

In an additional aspect, the first intermediate position is the position where a selected tonal noise is at a minimum for the second distance at the initial position.

In a further aspect, the final position is a position where the selected tonal noise is at a minimum.

In an additional aspect, the at least one obstruction is a sinusoidal obstruction forming a ring. The sinusoidal obstruction has a number of lobes.

In a further aspect the at least one obstruction is a number of equally spaced obstructions disposed in a circle.

In an additional aspect, the at least one obstruction is generally trapezoidal in shape.

In a further aspect, the harmonic content rate is less than 27%

In another aspect, the at least one obstruction is located upstream of the rotor.

In a further aspect, the at least one obstruction is located downstream of the rotor.

In an additional aspect, the method further comprises: selecting another tonal noise to be reduced; locating at least one other obstruction at another initial position being at a third distance radially away from the axis and at a fourth distance axially away from the rotor; moving the at least one other obstruction around the axis at another first intermediate position where the other tonal noise is reduced; modifying the fourth distance to locate the at least one other obstruction at another second intermediate position where the other tonal noise is further reduced; and repeating the steps of moving the at least one other obstruction and modifying the fourth distance until a desired level of reduction of the other tonal noise is obtained such that the at least one other obstruction is located at another final position. The at least one other obstruction being shaped such that an interaction of the at least one other obstruction with the rotor has a low harmonic content rate at the other final position.

In an additional aspect, the method further comprises: providing at least one actuator for moving the at least one obstruction; sensing the selected tonal noise; moving the at least one obstruction via the actuator to a position where the selected tonal noise is reduced in response to sensing a change in the tonal noise.

In another aspect, the invention provides an axial flow fan having a rotor rotatable about an axis. The rotor has a number of blades. The number of blades generate a number of tonal noises when the rotor is rotating in a non-uniform flow, the number of tonal noises each having a phase and a magnitude. At least one obstruction is positioned at a first distance radially away from the axis and at a second distance axially away from the rotor. The at least one obstruction is positioned around the axis such that the at least one obstruction generates a second noise, when in the non-uniform flow, having a phase that is out of phase with the phase of one of the number of tonal noises. The second distance is selected such that a magnitude of the second noise is substantially equal to the magnitude of the one of the number of tonal noises. The at least one obstruction is shaped such that an interaction of the at least one obstruction with the rotor has a low harmonic content rate.

In an additional aspect, the first distance is less than a span length of one of the number of blades.

In a further aspect, the axial flow fan has a shroud disposed around the rotor.

In an additional aspect, the at least one obstruction is a sinusoidal obstruction forming a ring, the sinusoidal obstruction having a number of lobes.

In a further aspect, the at least one obstruction is a number of equally spaced obstructions disposed in a circle.

In an additional aspect, the at least one obstruction is generally trapezoidal in shape.

In a further aspect, the harmonic content rate is less than 27%.

In an additional aspect, the at least one obstruction is located upstream of the rotor.

In a further aspect, the at least one obstruction is located downstream of the rotor.

In an additional aspect, the axial flow fan also has at least one other obstruction being positioned at a third distance radially away from the axis and at a fourth distance axially away from the rotor. The at least one other obstruction is positioned around the axis such that the at least one other obstruction generates a third noise, when in the non-uniform flow, having a phase that is out of phase with the phase of another of the number of tonal noises. The fourth distance is selected such that a magnitude of the third noise is substantially equal to the magnitude of the other of the number of tonal noises. The at least one other obstruction being shaped such that an interaction of the at least one other obstruction with the rotor has a low harmonic content rate.

In a further aspect, the axial flow fan also has an actuator for positioning the at least one obstruction.

In yet another aspect, the invention provides an axial flow fan having a rotor rotatable about an axis. The rotor has a number of blades. The number of blades generate a tonal noise at a blade passage frequency of the rotor when the rotor is rotating in a non-uniform flow. The tonal noise has a phase and a magnitude. The axial fan also has a sinusoidal obstruction forming a ring. The sinusoidal obstruction has a number of lobes equal to the number of blades. The ring is coaxial with the rotor. The sinusoidal obstruction is positioned around the axis such that the sinusoidal obstruction generates a second noise, when in the non-uniform flow, having a phase that is out of phase with the phase of the tonal noise. An axial distance between the sinusoidal obstruction and the rotor is selected such that a magnitude of the second noise is substantially equal to the magnitude of the tonal noise.

In yet another aspect, the invention provides an axial flow fan having a rotor rotatable about an axis. The rotor has a number of blades. The number of blades generate a tonal noise at a blade passage frequency of the rotor when the rotor is rotating in a non-uniform flow. The tonal noise has a phase and a magnitude. The axial fan also has a number of trapezoidal obstructions being disposed in a circle. The number of trapezoidal obstructions is equal to the number of blades. The circle is coaxial with the rotor. The number of trapezoidal obstructions are positioned around the axis such that the number of trapezoidal obstructions generate a second noise, when in the non-uniform flow, having a phase that is out of phase with the phase of the tonal noise. An axial distance between the number of trapezoidal obstructions and the rotor is selected such that a magnitude of the second noise is substantially equal to the magnitude of the tonal noise. The number of trapezoidal obstructions are shaped such that an interaction of the number of trapezoidal obstructions with the rotor has a low harmonic content rate.

In yet another aspect, the invention provides an axial flow fan having a rotor rotatable about an axis. The rotor has a number of blades. The number of blades generate a tonal noise at a blade passage frequency of the rotor when the rotor is rotating in a non-uniform flow. The tonal noise has a phase and a magnitude. The axial fan also has a number of shark fin shaped obstructions being disposed in a circle. The number of shark fin shaped obstructions is equal to the number of blades. The circle is coaxial with the rotor. The number of shark fin shaped obstructions are positioned around the axis such that the number of shark fin shaped obstructions generate a second noise, when in the non-uniform flow, having a phase that is out of phase with the phase of the tonal noise. An axial distance between the number of shark fin shaped obstructions and the rotor is selected such that a magnitude of the second noise is substantially equal to the magnitude of the tonal noise. The number of shark fin shaped obstructions are shaped such that an interaction of the number of obstructions with the rotor has a low harmonic content rate.

In yet another aspect, the invention provides axial flow fan having a rotor rotatable about an axis. The rotor has a number of blades. The number of blades generate a tonal noise at a blade passage frequency of the rotor when the rotor is rotating in a non-uniform flow. The tonal noise has a phase and a magnitude. The axial fan also has a single obstruction. The single obstruction is positioned around the axis such that the single obstruction generates a second noise, when in the non-uniform flow, having a phase that is out of phase with the phase of the tonal noise. An axial distance between the single obstruction and the rotor is selected such that a magnitude of the second noise is substantially equal to the magnitude of the tonal noise.

In yet another aspect, the invention provides a method for reducing tonal noise generated by an axial flow fan comprising: providing an axial flow fan having a rotor rotatable about an axis, the rotor having a number of blades, rotating the rotor in a non-uniform flow causing the number of blades to generate a first tonal noise at a blade passage frequency of the rotor and other tonal noises at harmonics of the blade passage frequency, the harmonics being integer multiples of the blade passage frequency, selecting a tonal noise to be reduced, locating at least one first obstruction at an initial position being at a first distance radially away from the axis and at a second distance axially away from the rotor, moving the at least one first obstruction around the axis at a first intermediate position where the selected tonal noise is reduced, locating at least one second obstruction at an initial position being at a third distance radially away from the axis and at a fourth distance axially away from the rotor, moving the at least one second obstruction around the axis at a second intermediate position where the selected tonal noise is reduced, and repeating the steps of moving the at least one first obstruction around the axis and moving the at least one second obstruction around the axis until a desired level of reduction of the selected tonal noise is obtained such that the at least one first obstruction and the at least one second obstruction are located at a final position.

In yet another aspect, the invention provides an axial flow fan having a rotor rotatable about an axis. The rotor has a number of blades. The number of blades generate a number of tonal noises when the rotor is rotating in a non-uniform flow. The number of tonal noises each have a phase and a magnitude. At least one first obstruction is positioned at a first distance radially away from the axis and at a second distance axially away from the rotor. At least one second obstruction is positioned at a third distance radially away from the axis and at a fourth distance axially away from the rotor. The at least one first obstruction is positioned around the axis such that the at least one first obstruction generates a second noise, when in the non-uniform flow. The at least one second obstruction being positioned around the axis such that the at least one second obstruction generates a third noise, when in the non-uniform flow. The combination of the second and third noises resulting in a fourth noise having a phase that is out of phase with the phase of one of the number of tonal noises and a magnitude that is substantially equal to the magnitude of the one of the number of tonal noises.

For purposes of this application, the terms “blade passage frequency” (or BPF) refer to the rate at which the blades of the rotor pass a fixed position. “Harmonics” are integer multiples of the BPF. For example, for a rotor having a BPF of 100 Hz, the first harmonic is twice the BPF, or 200 Hz, the second harmonic is thrice the BPF, or 300 Hz, and so on. The “harmonic content rate”, for the present application, is an indicator of the harmonic content of one or more obstructions. Obstructions having a low harmonic content rate do not significantly amplify tonal noise generated by the fan blades at harmonics higher than the one for which the obstructions were designed to reduce, and obstructions having a high harmonic content rate may significantly amplify tonal noise generated by the fan blades at harmonics higher than the one for which the obstructions were designed to reduce, as will be explained in greater details below.

Embodiments of the present invention each have at least one of the above-mentioned aspects, but do not necessarily have all of them.

Additional and/or alternative features, aspects, and advantages of the embodiments of the present invention will become apparent from the following description, the accompanying drawings, and the appended claims.

### BRIEF DESCRIPTION OF THE DRAWINGS

Having thus generally described the nature of the present invention, reference will now be made to the accompanying drawings by way of illustration showing a preferred embodiment, in which:

FIG. 1A is a schematic illustration of an arrangement of six cylindrical obstructions mounted to a ring which is an adaptation of a prior art arrangement;

FIG. 1B is a schematic illustration of an arrangement in accordance with the present invention of six generally trapezoidal obstructions disposed in a circle;

FIG. 1C is a schematic illustration of an arrangement in accordance with the present invention of a sinusoidal obstruction having six lobes;

FIG. 1D is a schematic illustration of an arrangement in accordance with the present invention of twelve generally trapezoidal obstructions disposed in a circle;

FIG. 1E is a schematic illustration of an arrangement in accordance with the present invention of six generally shark fin shaped obstructions disposed in a circle;

FIG. 1F is a schematic illustration of an arrangement in accordance with the present invention of a single generally trapezoidal obstruction;

FIG. 2A is a schematic illustration of a fan operating in a uniform flow;

FIG. 2B is a schematic illustration of a fan operating in a uniform flow;

FIG. 3 is a schematic illustration of the interaction between the unsteady lift modes of a fan and a set of obstructions shaped and positioned in accordance with the present invention;

FIG. 4 is a schematic illustration of the positioning of obstructions relative to the rotor of a fan;

FIG. 5 illustrates the unsteady lift spectra generated by various obstructions;

FIG. 6 illustrates the harmonic rate content of trapezoidal obstructions having various widths;

FIG. 7 is a front view of a rotor and obstruction arrangement, where the obstruction is located upstream of the rotor;

FIG. 8 is a top view of the arrangement of FIG. 7, with a radiator located between the obstruction and the rotor;

FIG. 9 is a side view of the arrangement of FIG. 8;

FIG. 10 is an isometric view of the arrangement of FIG. 7; and

FIG. 11 is a schematic illustration of a rotor and obstruction arrangement, where the obstruction is located downstream of the rotor.

### DETAILED DESCRIPTION OF THE INVENTION

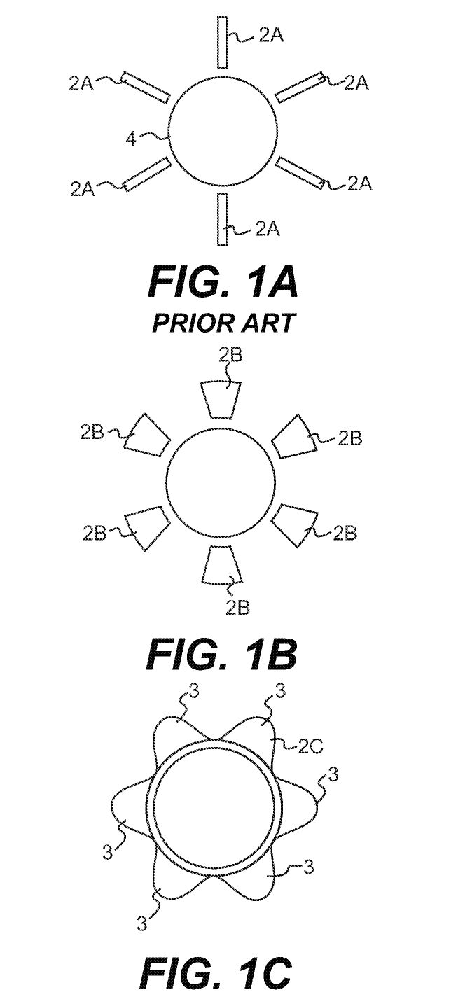

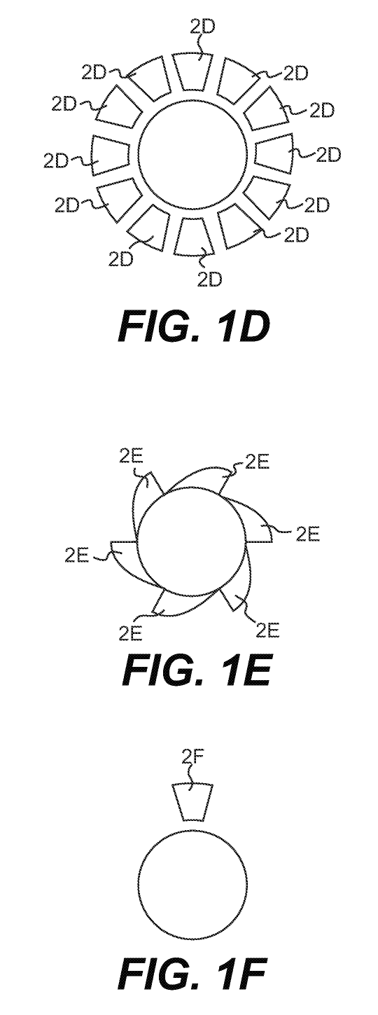

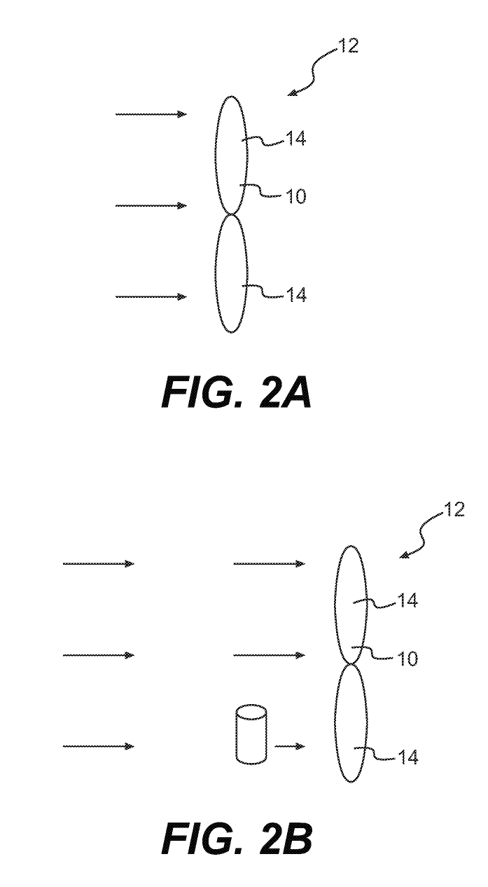

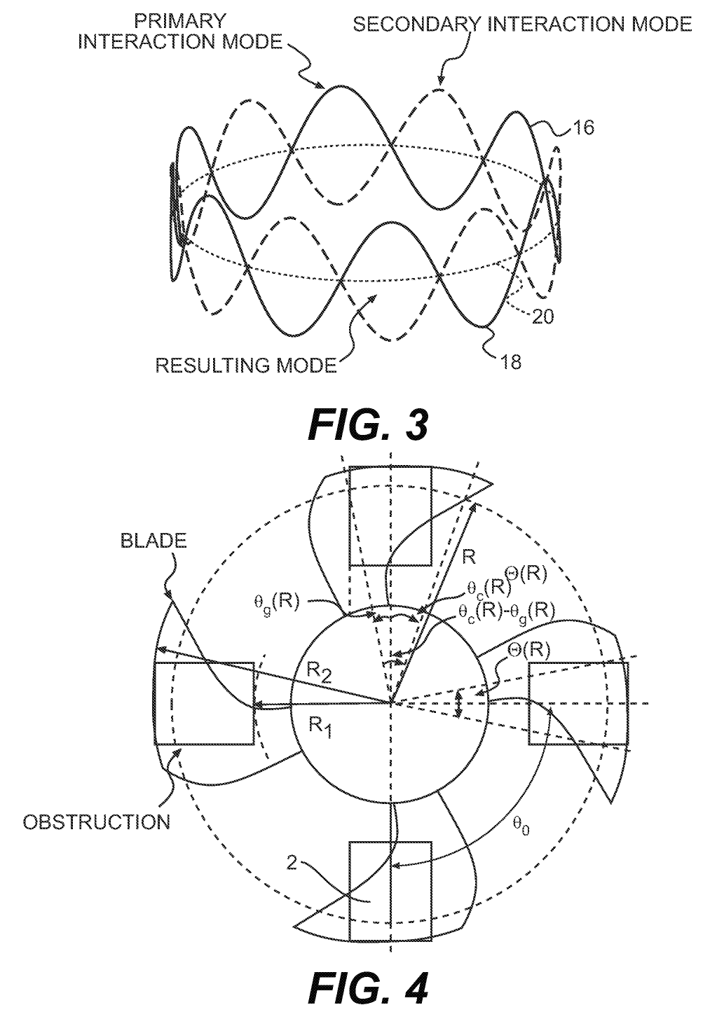

As explained above, when the rotor 10 of a fan 12 operates in a non-uniform flow, the blades 14 of the rotor 10 experience changes in angles of attack during rotation. This leads to primary unsteady lift modes 16, one order of which is schematically shown in FIG. 3. Primary unsteady lift modes 16 are a function of the non-uniform flow and the characteristics of the rotor (e.g. the number of blades 14), and the characteristics of the blades 14, such as sweep, camber, thickness, and angle of attack. The primary unsteady lift modes create tonal noises at the BPF and its harmonics. Positioning one or more obstructions, such as obstructions 2B to 2E shown in FIGS. 1B to 1E described in detail below, in the flow also creates unsteady lift modes, referred to as secondary unsteady lift modes 18, one order of which is schematically shown if FIG. 3. Secondary unsteady lift modes 18 also generate noises. By properly positioning the one or more obstructions in the non-uniform flow relative to the fan 12, it is possible to bring, for a selected tonal noise, a secondary unsteady lift mode 18 out of phase with a primary unsteady lift mode 16. As shown in FIG. 3, if the two unsteady lift modes 16, 18 are also of the same magnitude, the resulting unsteady lift mode 20 is zero, thereby eliminating the tonal noise. Should the secondary unsteady lift mode 18 not be perfectly out of phase and of the same magnitude as the primary unsteady lift mode 16, the tonal noise is nonetheless reduced. Determining the location of the one or more obstruction is achieved as described below.

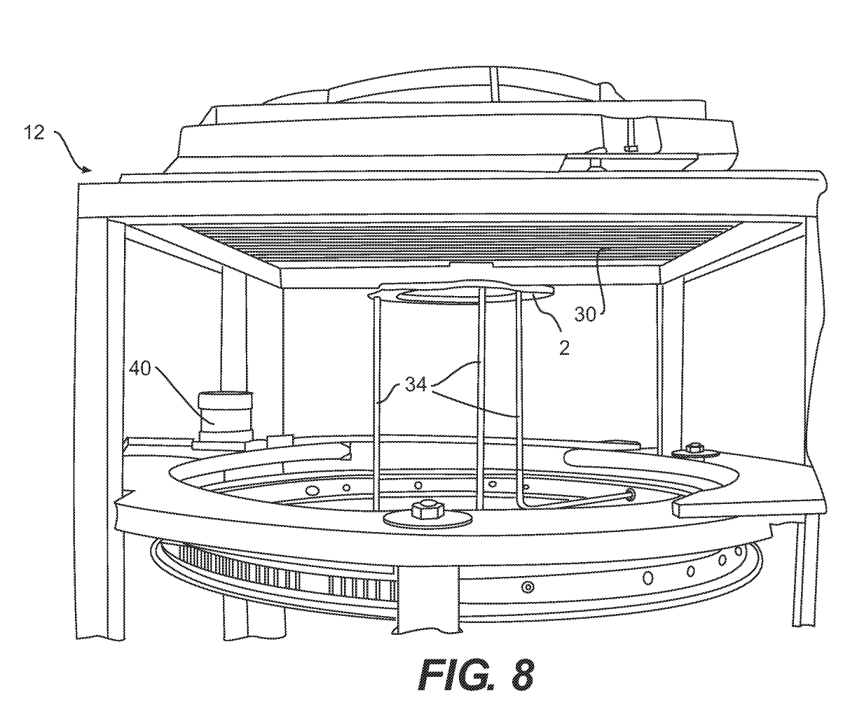

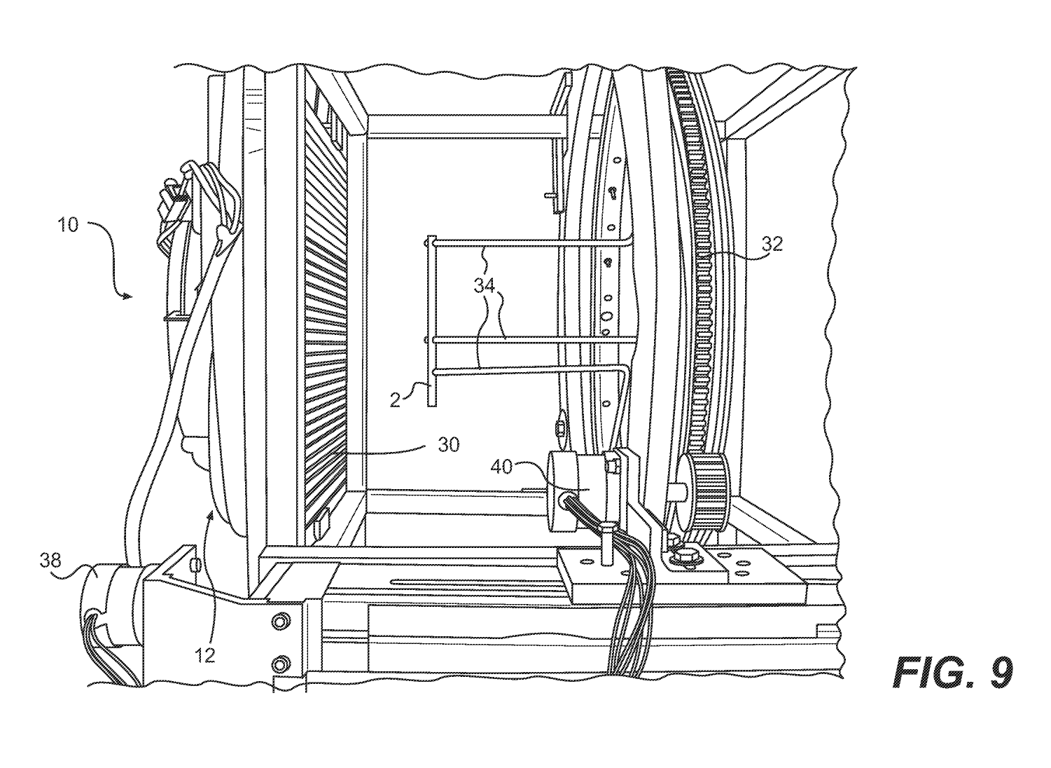

The steps for determining the final location of the one or more obstructions will be described below with respect to FIG. 4. As seen in FIG. 4, the rotor 10 of the fan 12 has four blades 14. The rotor 10 is first caused to rotate in the non-uniform flow causing the blades 14 to generate the tonal noises. The predominant tonal noise is the one generated at the BPF and is therefore the one which is normally selected to be attenuated. However, as will be described below, it is possible to use the same technique to reduce the tonal noises generated at the harmonics. A number of obstructions 2, shown as rectangular obstructions for simplicity, are then positioned in the non-uniform flow upstream (as in FIG. 8 for example) or downstream (as in FIG. 11 for example) of the rotor 10. The number of obstructions 2 used to reduce the tonal noise at the BPF is preferably equal to the number of blades 14, therefore four rectangular obstructions 2 are used. It is contemplated that a reduction in the tonal noise could also be achieved with a single obstruction 2 or a number of obstructions 2 which is less than the number of blades 14. The four rectangular obstructions 2 are preferably disposed in a circle 6 and, for a rotor 10 having blades 14 of equal pitch, are equally spaced from each other. The center of the circle 6 is preferably coaxial with the center 22 of the rotor 10. The obstructions 2 are initially disposed at a distance R1 from the center 22 of the rotor 10 and are located a certain axial distance away from the rotor 10. It is contemplated that the obstructions 2 could be located at the center 22 and extend away therefrom. It is also contemplated that a portion of the obstructions 2 could extend beyond the span length of the blades 14.

Rotating the obstructions 2 around the center 22 changes the phase of the secondary unsteady lift mode 18, or noise, generated by the obstructions 2 and moving the obstructions 2 axially with respect to the rotor 10 changes the amplitude of the secondary unsteady lift mode 18, or noise, generated by the obstructions 2. Therefore to reduce the tonal noise, the obstructions 2 are rotated in a first direction. If the tonal noise is reduced, the obstructions 2 continue to be rotated as long as the tonal noise continues to be reduced. If the tonal noise increases when the obstructions 2 are rotated in the first direction, they are rotated in the opposite direction as long as the tonal noise continues to be reduced. When the obstructions 2 are at the location offering the most reduction in tonal noise, they are then moved in a first axial direction relative to the rotor 10. If the tonal noise is reduced, the obstructions 2 continue to be moved in the same axial direction as long as the tonal noise continues to be reduced. If the tonal noise increases when the obstructions 2 are moved in the first axial direction, they are moved in the opposite axial direction as long as the tonal noise continues to be reduced. The steps of rotating and axially moving the obstructions 2 are repeated until the desired level of reduction of tonal noise is obtained, bringing the obstructions 2 to a final position. Preferably, the desired level of reduction of the tonal noise is reached when the tonal noise is a minimum. It should be understood that the step of axially moving the obstructions 2 can be done before the step of rotating the obstructions 2. It is also contemplated that the radial distance R1 between the obstructions 2 and the center 22 could also be modified to reduce the tonal noise.

As mentioned above, it is also possible to use the same technique to reduce the tonal noise generated at harmonics of the BPF. In those cases, the number of obstructions 2 is preferably an integer multiple of the number of blades 14 corresponding to an integer multiple of the corresponding harmonic for which the tonal noise is to be reduced. For example, to reduce the tonal noise generated by the blades of a six bladed rotor 10 at the first harmonic (which is twice the BPF), the number of obstructions 2 used is preferably twice the number of blades 14, therefore twelve obstructions would preferably be used, as shown in FIG. 1D. To reduce the tonal noise at the second harmonic (which is thrice the BPF) for a six bladed rotor 10, eighteen obstructions 2 would preferably be used.

It is possible to combine multiple sets of obstructions 2 to reduce multiple tonal noises, as shown in FIG. 11. A first set 24 of obstructions 2 can first be positioned to reduce the tonal noise generated at the BPF, for example, and a second set 26 of obstructions 2 can then be positioned to reduce the tonal noise generated the first harmonic, for example. The obstructions 2 of each set 24, 26 are preferably of similar shape. In the case of a six-bladed rotor 10, for the example given, the first set 24 would preferably have six obstructions 2, one possible example of which is shown in FIG. 1B, and the second set 26 would preferably have twelve obstructions 2, one possible example of which is shown in FIG. 1D. As shown in FIG. 11, the two sets 24, 26 of obstructions 2 can be positioned at different axial distances from the rotor 10. It is also contemplated that the two sets 24, 26 of obstructions 2 could be disposed at the same axial distance from the rotor 10, but at different radial distances from the center 22, such that one set is disposed inside the other.

It is also possible to combine multiple sets of obstructions 2 to reduce the same tonal noise. The arrangement of the sets is the same the one shown in FIG. 11. The first and second sets 24, 26 of obstructions 2 are positioned such that the secondary unsteady lift modes of the first and second sets 24, 26 result, when combined, in a combined unsteady lift mode that reduces the selected tonal noise. Preferably, the combined secondary unsteady lift mode of the first and second sets 24, 26 results in an unsteady lift mode that has the same magnitude and is out of phase with the primary unsteady lift mode radiating noise at the selected tonal noise. This arrangement allows the desired level of reduction of tonal noise to be obtained by rotating the first and second sets 24, 26 around the central axis while maintaining the axial distance between the first and second sets 24, 26 and the rotor 10 constant. This is because changing the phase generated by one or both sets of obstructions 2 not only changes the phase of the combined unsteady lift mode but also the amplitude of the combined unsteady lift mode, even though the amplitude of the individual unsteady lift modes remain the same. Since the axial distance between the first and second sets 24, 26 and the rotor 10 do no need to be modified, the arrangement of the first and second sets 24, 26 and the rotor 10 can be more compact in the axial direction. Also, since the sets of obstructions 2 only need to be rotated, there is no need to provide actuators to move the sets of obstructions 2 in the axial direction in the case where the positioning of the obstructions 2 is to be automated. It is contemplated that more than two sets of obstructions could be used to reduce the same tonal noise. It is also contemplated that multiple sets of obstructions 2 could be used to reduce a first tonal noise and that multiple sets of obstructions 2 could be used to reduce a second tonal noise generated by the same rotor 10.

It is also possible to use a single obstruction 2 having a number of lobes 3, such as obstruction 2C shown in FIG. 1C. In the case of single obstructions 2 having lobes 3, the above explanation regarding the preferred number of obstructions 2 now apply to the number of lobes. Therefore, to reduce the tonal noise generated by a six-bladed fan at the BPF, the single obstruction 2 would preferably have six lobes 3, as shown in FIG. 1C. To reduce the tonal noise generated by a six-bladed fan at the first harmonic (which is twice the BPF), the single obstruction 2 would preferably have twelve lobes 3.

As mentioned above, when the obstructions 2 are located in the non-uniform flow, they generate noises, referred to as the harmonic content. Noise generated by the obstructions 2 at the frequency of the tonal noise which is selected to be reduced can be used to reduce it as mentioned above. However, noises are also generated by the obstructions 2 at other frequencies, including the harmonics of the rotor 10. Since the phase of these other noises cannot be adjusted, because they are set by the position of the obstructions 2 to reduce the selected tonal noise, they may interfere with the tonal noises generated at the higher harmonics so as to increase rather than reduce them. For this reason, care must be take in the design of the shapes of the obstructions 2. The obstructions 2 have to be shaped so that the predominant noise generated by the obstructions 2 is generated at the frequency of the tonal noise which is to be reduced. The noises generated by the obstructions 2 at the higher frequency are preferably negligible relative to the predominant noise in order to have little effect on the tonal noises generated by the rotor at the higher harmonics. The ratio of the predominant noise versus the other noises generated at the harmonics of the rotor 10 by the obstructions 2 can be expressed as a percentage. This percentage is defined as the harmonic content rate D(%), and can be determined by the following equation:

$$D ( \% ) = \sqrt{\frac{{\sum }_{n = 2}^{{n}_{max}} {\vert \hat{L} ( nN ) \vert}^{2}}{{\sum }_{n = 1}^{{n}_{max}} {\vert \hat{L} ( nN ) \vert}^{2}}} ⨯ 100$$

where L is the unsteady lift mode, N is the number of obstructions or lobes, and n the circumferential order harmonic of N (n=1 for the BPF, n=2 for the first harmonic, . . . ). The unsteady lift modes can be determined by the following equation:

$$\hat{L} ( nN ) = {π}^{3 / 2} {ρ}_{0} Ω {\sum }_{m = - ∞}^{+ ∞} sin c ( π ( m + n ) ) {\int }_{{R}_{1}}^{{R}_{2}} \frac{{v}_{m} ( R )}{A ( R )} C ( R )$$

$${Re}^{\frac{- {m}^{2} {n}^{2}}{{A}^{2} ( R )}} {ⅇ}^{ⅈ w ( {θ}_{c} ( R ) - {θ}_{g} ( R ) )} {S}_{c} ( {σ}_{θ} , {M}_{n} ) ⅆ R$$

which uses the coordinate system illustrated in FIG. 4. The details and explanations regarding this equation are provided in the article entitled “Control of Tonal Noise From Subsonic Axial Fans Using Flow Control Obstructions. Part I: Interaction Between the Flow Control Obstructions and the Rotor”. This article was annexed to the provisional application to which the present application claims priority.

Therefore one or more obstructions need to be shaped such that their harmonic content rate D(%) is low so has to have a minimal effect on the higher harmonics of the rotor. For example, in the case where obstructions are to be provided for a six-bladed automotive engine cooling fan having an inner radius of 6.25 cm, an outer radius of 15 cm, and swept blades, the harmonic content rate D(%) is preferably less than 27%. It should be noted that the preferable harmonic rate may vary depending on the application. Also note that an obstruction generating a purely sinusoidal unsteady lift would have a harmonic content rate of zero.

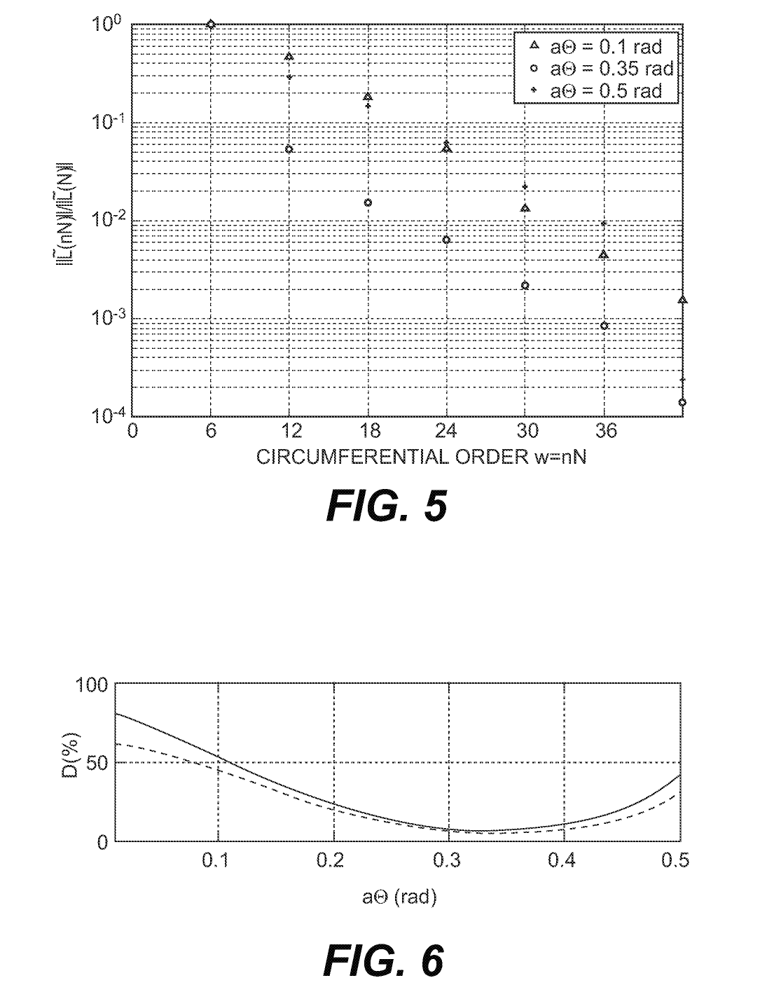

FIG. 5 provides an example of the normalized unsteady lift spectrum associated with various wake sizes at various circumferential orders for the interaction of the obstructions 2 with a six-bladed rotor 10. The circumferential order (w) is equal to the number of blades (N) multiplied by the circumferential order harmonic of N (n). The shape of the obstruction 2 affects the size of the wake. Generally, narrow obstructions 2 have narrow wakes, and wide obstructions 2 have wide wakes. As can be seen in FIG. 5, the unsteady lift spectrum decreases much faster for obstructions 2 having a properly sized wake (shown by the circles) as the circumferential order increases, than for obstructions 2 having narrow (shown by the triangles) or wide (shown by the crosses) wakes. Thus, a properly sized obstructions 2 has less effect on the tonal noises generated at the higher harmonics than ones which are too narrow or too wide.

FIG. 6 illustrates an example of the harmonic content rate for various wake widths. Here it can be seen that narrow and wide obstructions have a high harmonic content rate, which is undesirable for the reasons explained above.

FIGS. 1B, 1C, and 1E schematically illustrate obstructions having shapes that, when properly sized, would generate a low harmonic content rate when used to control the tonal noise generated at the BPF by a rotor 10 having six blades 14. FIG. 1D illustrates obstructions having shapes that, when properly sized, would generate a low harmonic content rate when used to control the tonal noise generated at the first harmonic by a rotor 10 having six blades 14, or at the BPF by a rotor 10 having 12 blades. FIGS. 1B and 1D show trapezoidal obstructions 2B and 2D respectively disposed in a circle. FIG. 1C shows a sinusoidal obstruction 2C forming a ring and having six lobes 3. FIG. 1E shows an optimized set of shark fin shaped obstructions. It would be understood by a person skilled in the art that many other shapes and configurations of obstructions are possible which would also have a low harmonic content rate, such as three-dimensional obstructions.

It is contemplated that a single obstruction, such as generally trapezoidal obstruction 2F shown in FIG. 1F, could be used. Although using a single obstruction 2F may lead to a higher harmonic content rate than the examples shown in FIGS. 1B to 1E, it can nonetheless be positioned such that it controls a selected tonal noise. Such an arrangement would preferably be used at low rotation speeds of the rotor 10 and in cases where potential amplification of the higher harmonics is less of a concern.

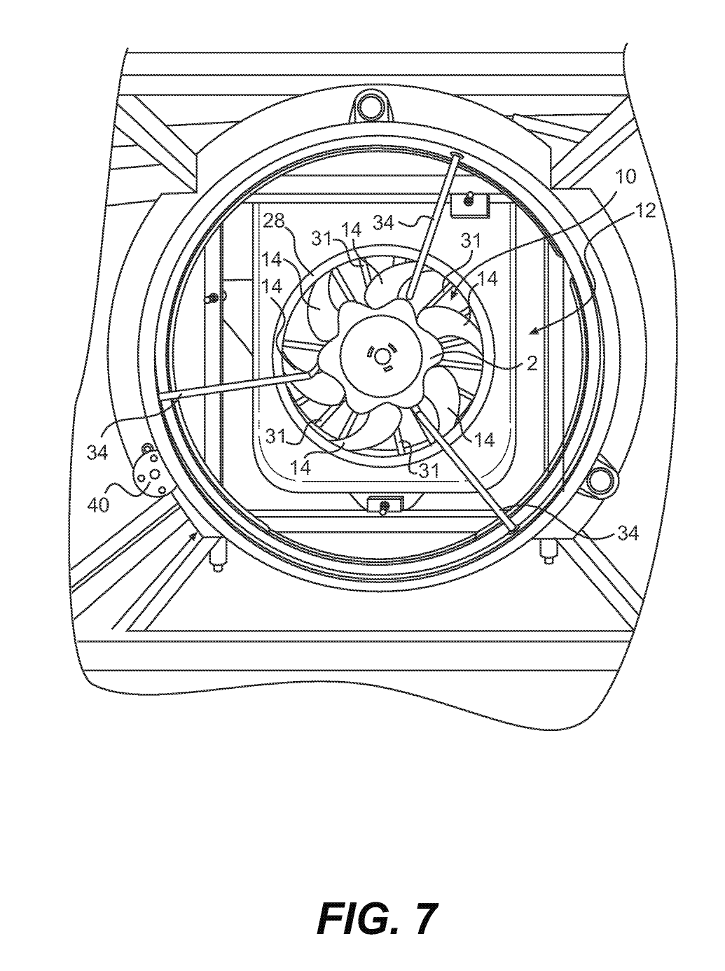

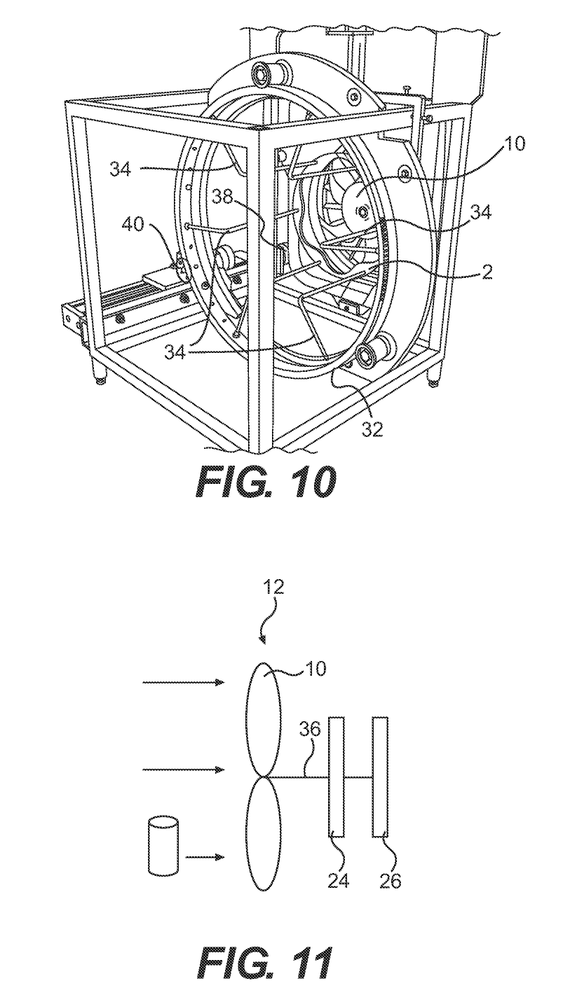

FIGS. 7 to 10 illustrate one possible embodiment of an axial fan 12 having a rotor 10 and an obstruction 2 to reduce the tonal noise generated by the blades 14 of the rotor 10 when used in a non-uniform flow. In these figures, the axial fan 12 is a radiator fan. A rotor 10 of the fan 12 has six blades 14. The blades 14 rotate inside a shroud 28. It is contemplated that no shroud could be provided. A radiator 30 located upstream of the rotor 10 and stator vanes 31 cause the non-uniform flow. A sinusoidal obstruction 2, similar to obstruction 2C of FIG. 1C, is mounted to a support 32 via rods 34. As shown in FIG. 7, the support 32 can be rotated and translated to properly position the obstruction 2 to reduce the tonal noise generated by the rotor 10 due to the non-uniform flow. Once the amount of reduction is obtained, the support 32 is fixed in place. FIG. 11 schematically illustrates another way of mounting obstructions to a rotor 10. In FIG. 11, the rotor 10 turns around a fixed shaft 36, a set of obstructions, set 24 for example, is mounted on the shaft 36 so as to be rotated and translated thereon. Once the desired amount of reduction of the tonal noise is obtained, the set 24 is fixed in place. Alternatively, the obstructions could be mounted inside a duct.

As can be seen in FIGS. 7 to 10, the relatively small size of the obstruction 2 compared to the rotor 10 and the radiator 30 allows it to be easily located in a confined environment.

Although the above example shows the use of obstructions with a radiator fan, the obstructions and method of locating them can be used in almost any subsonic axial fan. Computer fans, aircraft propellers, and fans of turbo-fan aircraft engines are only some examples of applications where the obstructions described herein could be used.

Over time the non-uniform flow in some applications may change. For example, flies get caught in the radiator of a car, or dust gather on the fan of a computer. This change in the non-uniform flow will result in a change in the primary unsteady lift modes of the rotor 10. Depending on the degree of variation, the obstruction 2 may need to be repositioned. Returning to FIGS. 7 to 10, actuators 38 and 40 can be used to automatically reposition the obstruction 2. Actuator 38 controls the translation of the obstruction 2, and actuator 40 controls the rotation of the obstruction 2. A sensor (not shown), in the form of a microphone for example, senses a variation in the tonal noise. Through a computer algorithm which replicates the steps described above to initially position the obstruction 2, the actuators 38, 40 move the obstruction 2 to a new position where the tonal noise is reduced to a desired level. The actuators 38, 40, sensor, and computer algorithm can also be used to provide the initial position of the obstruction 2.

Modifications and improvements to the above-described embodiments of the present invention may become apparent to those skilled in the art. The foregoing description is intended to be exemplary rather than limiting. The scope of the present invention is therefore intended to be limited solely by the scope of the appended claims.

1. A method for reducing tonal noise generated by an axial flow fan comprising:
providing an axial flow fan having a rotor rotatable about an axis, the rotor having a number of blades;
rotating the rotor in a non-uniform flow causing the number of blades to generate a first tonal noise at a blade passage frequency of the rotor and other tonal noises at harmonics of the blade passage frequency, the harmonics being integer multiples of the blade passage frequency;
selecting a tonal noise to be reduced;
locating at least one obstruction at an initial position being at a first distance radially away from the axis and at a second distance axially away from the rotor;
moving the at least one obstruction around the axis at a first intermediate position where the selected tonal noise is reduced;
modifying the second distance to locate the at least one obstruction at a second intermediate position where the selected tonal noise is further reduced; and
repeating the steps of moving the at least one obstruction and modifying the second distance until a desired level of reduction of the selected tonal noise is obtained such that the at least one obstruction is located at a final position,
the at least one obstruction being shaped such that an interaction of the at least one obstruction with the rotor has a low harmonic content rate at the final position.

2. (canceled)

3. The method of claim 1, further comprising modifying the first distance.

4. (canceled)

5. (canceled)

6. The method of claim 1, wherein the at least one obstruction is a sinusoidal obstruction forming a ring, the sinusoidal obstruction having a number of lobes,
wherein the number of lobes of the sinusoidal obstruction is equal to the number of blades of the rotor when the selected tonal noise is the tonal noise at the blade passage frequency, and
wherein the number of lobes of the sinusoidal obstruction is equal to an integer multiple of the number of blades of the rotor when the selected tonal noise is the tonal noise at one of the harmonics, the integer multiple of the number of blades corresponding to the integer multiple of the corresponding harmonic.

7.-9. (canceled)

10. The method of claim 1, wherein the at least one obstruction is a number of equally spaced obstructions disposed in a circle,
wherein the number of obstructions is equal to the number of blades of the rotor when the selected tonal noise is the tonal noise at the blade passage frequency, and
wherein the number of obstructions is equal to an integer multiple of the number of blades of the rotor when the selected tonal noise is the tonal noise at one of the harmonics, the integer multiple of the number of blades corresponding to the integer multiple of the one harmonic.

11.-13. (canceled)

14. The method of claim 1, wherein the at least one obstruction is generally trapezoidal in shape.

15.-17. (canceled)

18. The method of claim 1, further comprising:
selecting another tonal noise to be reduced;
locating at least one other obstruction at another initial position being at a third distance radially away from the axis and at a fourth distance axially away from the rotor;
moving the at least one other obstruction around the axis at another first intermediate position where the other tonal noise is reduced;
modifying the fourth distance to locate the at least one other obstruction at another second intermediate position where the other tonal noise is further reduced; and
repeating the steps of moving the at least one other obstruction and modifying the fourth distance until a desired level of reduction of the other tonal noise is obtained such that the at least one other obstruction is located at another final position,
the at least one other obstruction being shaped such that an interaction of the at least one other obstruction with the rotor has a low harmonic content rate at the other final position.

19.-22. (canceled)

23. The method of claim 1, further comprising:
providing at least one actuator for moving the at least one obstruction;
sensing the selected tonal noise;
moving the at least one obstruction via the actuator to a position where the selected tonal noise is reduced in response to sensing a change in the tonal noise.

24. (canceled)

25. (canceled)

26. An axial flow fan comprising:
a rotor rotatable about an axis, the rotor having a number of blades, the number of blades generating a number of tonal noises when the rotor is rotating in a non-uniform flow, the number of tonal noises each having a phase and a magnitude; and
at least one obstruction being positioned at a first distance radially away from the axis and at a second distance axially away from the rotor,
the at least one obstruction being positioned around the axis such that the at least one obstruction generates a second noise, when in the non-uniform flow, having a phase that is out of phase with the phase of one of the number of tonal noises,
the second distance being selected such that a magnitude of the second noise is substantially equal to the magnitude of the one of the number of tonal noises, and
the at least one obstruction being shaped such that an interaction of the at least one obstruction with the rotor has a low harmonic content rate.

27. (canceled)

28. (canceled)

29. The axial flow fan of claim 26, wherein the at least one obstruction is a sinusoidal obstruction forming a ring, the sinusoidal obstruction having a number of lobes.

30. The axial flow fan of claim 29, wherein the number of lobes of the sinusoidal obstruction is equal to the number of blades of the rotor.

31. The axial flow fan of claim 29, wherein the number of lobes of the sinusoidal obstruction is equal to an integer multiple of the number of blades of the rotor.

32. (canceled)

33. The axial flow fan of claim 26, wherein the at least one obstruction is a number of equally spaced obstructions disposed in a circle.

34. The axial flow fan of claim 33, wherein the number of obstructions is equal to the number of blades of the rotor.

35. The axial flow fan of claim 33, wherein the number of obstructions is equal to an integer multiple of the number of blades of the rotor.

36. (canceled)

37. The axial flow fan of claim 26, wherein the at least one obstruction is generally trapezoidal in shape.

38.-40. (canceled)

41. The axial flow fan of claim 26, further comprising:
at least one other obstruction being positioned at a third distance radially away from the axis and at a fourth distance axially away from the rotor;
the at least one other obstruction being positioned around the axis such that the at least one other obstruction generates a third noise, when in the non-uniform flow, having a phase that is out of phase with the phase of another of the number of tonal noises,
the fourth distance being selected such that a magnitude of the third noise is substantially equal to the magnitude of the other of the number of tonal noises, and
the at least one other obstruction being shaped such that an interaction of the at least one other obstruction with the rotor has a low harmonic content rate.

42.-53. (canceled)

54. An axial flow fan comprising:
a rotor rotatable about an axis, the rotor having a number of blades, the number of blades generating a number of tonal noises when the rotor is rotating in a non-uniform flow, the number of tonal noises each having a phase and a magnitude;
at least one first obstruction being positioned at a first distance radially away from the axis and at a second distance axially away from the rotor; and
at least one second obstruction being positioned at a third distance radially away from the axis and at a fourth distance axially away from the rotor;
the at least one first obstruction being positioned around the axis such that the at least one first obstruction generates a second noise, when in the non-uniform flow;
the at least one second obstruction being positioned around the axis such that the at least one second obstruction generates a third noise, when in the non-uniform flow;
the combination of the second and third noises resulting in a fourth noise having a phase that is out of phase with the phase of one of the number of tonal noises and a magnitude that is substantially equal to the magnitude of the one of the number of tonal noises.

55. The axial flow fan of claim 54, wherein at least one of the at least one first obstruction and the at least one second obstruction is shaped such that an interaction of the at least one of the at least one first obstruction and the at least one second obstruction with the rotor has a low harmonic content rate.

56. The axial flow fan of claim 54, wherein the at least one first obstruction and the at least one second obstruction are shaped such that an interaction of the at least one first obstruction and the at least one second obstruction with the rotor has a low harmonic content rate.

57. The axial flow fan of claim 54, further comprising:
at least one third obstruction being positioned at a fifth distance radially away from the axis and at a sixth distance axially away from the rotor; and
at least one fourth obstruction being positioned at a seventh distance radially away from the axis and at an eighth distance axially away from the rotor;
the at least one third obstruction being positioned around the axis such that the at least one third obstruction generates a fifth noise, when in the non-uniform flow;
the at least one fourth obstruction being positioned around the axis such that the at least one fourth obstruction generates a sixth noise, when in the non-uniform flow;
the combination of the fifth and sixth noises resulting in a seventh noise having a phase that is out of phase with the phase of another one of the number of tonal noises and a magnitude that is substantially equal to the magnitude of the other of the number of tonal noises.
